(19) United States
(12) Patent Application Publication
(10) Pub. No.: US 2026/0179407 A1
(43) Pub. Date: Jun. 25, 2026

(54) CLASSIFICATION-BASED DATA HANDLING WITH LANGUAGE MODEL EXTRACTION

(71) Applicant: Intuit Inc., Mountain View, CA (US)

(72) Inventors: Justin Rui Chang CHIANG, San Diego, CA (US); Ryan RICH, Oceanside, CA (US); Joshin Jacob Shaji KARIYATHU, Santa Clara, CA (US); Mohsin Akhtar MALIK, Buffalo, NY (US); Daniel Wen ZHANG, Santa Clara, CA (US); Nankun HUANG, San Diego, CA (US)

(21) Appl. No.: 18/991,117

(22) Filed: Dec. 20, 2024

(51) Int. Cl. G06V 30/413; G06F 16/34; G06V 30/148; G06V 30/414

(52) U.S. Cl. CPC G06V 30/413; G06F 16/345; G06V 30/153; G06V 30/414

(57) ABSTRACT

Certain aspects of the disclosure provide techniques for data handling. A method generally includes determining, using a classification element, a form type of a document; identifying a first language model (LM) and a schema associated with the form type; prompting the first LM to: extract, from the document, a plurality of values for a plurality of entities defined in the schema, and generate, based on the plurality of values, a structured output in compliance with the schema; receiving, from the first LM, the structured output; populating an electronic form based on the structured output; and outputting the electronic form.

### BACKGROUND

### Field

Aspects of the present disclosure relate to techniques for data handling.

### Description of Related Art

Data handling refers to techniques for collecting, organizing, managing, processing, and/or analyzing data. Data handling essentially encompasses all steps from gathering raw data to presenting it in a useful format for analysis and/or dissemination. In some cases, data handling includes data extraction and form population, such as to extract and convert data into a usable format for further analysis, reporting, and/or storage, among other tasks.

Specifically, data extraction is the process of extracting data and making it available for use in a downstream process (e.g., application). Data may be extracted from various sources, including structured and/or unstructured documents. As used herein, a document may refer to a collection of information and/or data that is presented in written, visual, or digital format. Further, a structured document may refer to a document with a predefined format, where data is organized in a consistent way making it easy to store, search for, and/or extract specific data from these documents. Data included in structured documents may be referred to herein as “structured data.” Example structured documents may include forms (e.g., such as electronic forms), spreadsheets, JavaScript Object Notation (JSON) documents, extensible markup language (XML) documents, and more. Unstructured documents, in contrast, may lack a pre-defined structure or format. For example, data included in an unstructured document may not follow any specific template and/or schema. Unstructured documents may include a variety of data types (e.g., such as text, images, multimedia, etc.), and often include content that is free-form or narrative. Data included in unstructured documents may be referred to herein as “unstructured data.” Example unstructured documents may include text documents (e.g., letters, memos, reports, or essays that do not follow a specific schema), images, audio files, video files, social media posts, emails (e.g., while emails may generally include a subject, data, and sender, the body of the email may vary widely in format), sensor data, and more. Overall, structured documents may be easy to categorize and search, while unstructured documents may require more complex analysis techniques to extract meaningful data.

Form population refers to a process for entering information into a form, such as by filling in one or more fields of the form with pre-existing data. As used herein, a “form” is an example structured document consisting of multiple fields, or designated spaces for entering or selecting specific data. Forms are often associated with templates, which provide the pre-defined structure or layout that organizes the fields within the form. In other words, a form template may be a blueprint for creating a particular form, ensuring consistency, standardization, and/or efficiency in data collection. Forms may be either paper-based or electronic (e.g., or digital equivalents of paper-based forms used for collecting, processing, and storing information).

The existing data that is entered into a form may include unstructured or structured data extracted from various sources (e.g., using data extraction techniques described above). In some instances, data extraction and form population may be used to extract and transform unstructured data into a structured format (e.g., populate a form), such that it can be used for downstream processing.

As an illustrative example, a financial management system may facilitate the generation of electronic financial forms, such as electronic invoices, estimates, bills, receipts, and/or the like, from paper-based financial documents (e.g., printed invoices, scanned receipts, etc.). Users may extract data from these paper-based financial documents and populate one or more of the electronic forms provided by the system in order to generate electronic financial documents that may be used in managing their business. For instance, a user may utilize a financial management application, such as QuickBooks® made commercially available by Intuit of Mountain View, California, for bill processing. Information included in hard copy invoices from suppliers may be extracted and recorded in QuickBooks® so as to enable the user to manage these electronic bills until payment is completed.

Although the above example describes the use of data extraction techniques for electronic financial form generation, data extraction techniques may be similarly used in other industries, such as healthcare, marketing, logistics, insurance, mortgage, and/or commercial real estate, among others, for populating electronic forms.

### SUMMARY

Certain embodiments provide a method of classification-based data handling, comprising: determining, using a classification element, a form type of a document; identifying a first language model (LM) and a schema associated with the form type; prompting the first LM to: extract, from the document, a plurality of values for a plurality of entities defined in the schema, and generate, based on the plurality of values, a structured output in compliance with the schema; receiving, from the first LM, the structured output; populating an electronic form based on the structured output; and outputting the electronic form.

Certain embodiments provide a method of data handling, comprising: prompting a first language model (LM) to: extract, from a document, a plurality of values for a plurality of entities defined in a schema; and generate; based on the plurality of values, a structured output in compliance with the schema; receiving, from the first LM, the structured output; populating an electronic form based on the structured output; obtaining one or more analytics associated with prompting the first LM and populating the electronic form; and storing the document, the electronic form, and the one or more analytics in a repository.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system implementing an electronic form generator.

FIG. 2 depicts an example workflow for classification-based data handling with language model extraction.

FIG. 3 depicts an example invoice schema.

FIG. 4 depicts an example bill schema.

FIGS. 5A and 5B depict example prompts for entity extraction and structure output generation.

FIGS. 6A-6C depict example electronic invoice population using unstructured data.

FIG. 7 depicts an example method of classification-based data handling.

FIG. 8 depicts an example method of data handling.

FIG. 9 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Conventional methods of electronic form population may involve manually extracting data from unstructured documents, and using the extracted data to populate one or more forms. For example, a human may manually transpose data from physical and/or digital documents into a desired, electronic format. Manual data extraction and entry may require the human to read through document(s), identify relevant information, and reproduce this information, such as by typing and/or copying and pasting the information, into one or more fields of a form (e.g., in the desired format). Manual data extraction and form population may be particularly useful where precision and/or a nuanced understanding of complex, unstructured documents are critical for generating the form.

However, manual data extraction and form population is slow and often prone to errors. For example, a notable problem with manual data extraction and form population is the inevitability of mistakes, such as mistyped words and/or numbers. Best intentions aside, even the most meticulous individuals make occasional data entry mistakes. While data extraction and form entry errors may seem routine and mostly innocuous in day-to-day life, in high-risk industries (e.g., healthcare, finance, engineering, science, transportation, etc.), such an error may lead to serious injury, loss of life, loss of assets, destruction of property, legal liability, and the like. As an illustrative example, a user retrieving income information for an employee in a previous year from a W-2 form may incorrectly populate an electronic tax form, provided via tax preparation software. Tax penalties may be imposed on the employee based on this incorrect tax information, and in some cases, may subject the employee to legal liability.

Further, manual data extraction and form population is generally labor-intensive and, in some cases, may significantly delay subsequent tasks (e.g., such as issuing payment, billing a client, processing paperwork, etc.). Specifically, manual data extraction and form population is a fundamentally inefficient approach that involves humans spending hours manually retrieving and entering data into a system. Delays resulting from this approach may affect efficiencies of an organization that relies on these forms for further processing. For example, delayed generation of electronic bills may cause delays in payments issued by a business, thereby, in some cases, causing the business to incur additional late fees for the delayed payments. Additionally, as data requirements increase, manual data extraction and form population may become difficult to scale up. For example, manual data extraction and form population may induce significant latencies in downstream processing that make it technically unsuitable for a time-sensitive process.

Accordingly, manual methods are not effective for extracting data for form population in many contexts. Automated solutions, by contrast, may use software to automatically identify and extract relevant information from various sources and then populate that data directly into designated field(s) of an electronic form, eliminating the need for manual data entry. While automatic data extraction and form population, offer several advantages, such as increased efficiency and reduced human error, such techniques are not without limitations. For example, the software may struggle to accurately identify and extract relevant data consistently from unstructured documents. In some cases, this may be due to data ambiguity, as unstructured documents may contain text with varied sentence structures, slang, and/or multiple meanings, making it difficult for algorithms to interpret correctly. Additionally, contextual understanding by the software may be required to extract relevant data, as the meaning of information may change depending on the surrounding context. Furthermore, unstructured data may contain noise, such as irrelevant details and/or formatting inconsistencies, which may need to be handled during the extraction. As such, automatic methods for data extraction and form population, that overcome these challenges, may be desired.

Embodiments described herein overcome the aforementioned technical problems and improve upon the state of the art by providing an automated solution for data handling, which uses natural language processing (NLP) techniques to properly extract information, such as from unstructured documents, for electronic form population. For example, a handler (e.g., a function, a method, a block of code, etc.) may utilize a language model (LM) (e.g., such as a large language model (LLM)) to extract information from an unstructured document and generate, based on the extracted information, a structured output in compliance with a schema. The handler may subsequently use the structured output to generate the particular, electronic form, such as by populating the electronic form with information included in the structured output.

As used herein, a schema may refer to a structured framework that specifies the entities and structure of a particular, electronic form, such as the fields (e.g., the individual entities of the form) included in the form, as well as their types (e.g., data types and/or formats), default values, constraints (e.g., limits on field values), rules, and/or other properties. By encompassing these components, a schema may be used to guide a handler (and more specifically, an LM) in the extraction and generation of a structured output, which may be subsequently used to populate a particular, electronic form. That is, the structured output generated based on the schema may include fields and field values that conform to the rules and/or structure of the schema, making it easy to process and use this information for population of the particular, electronic form.

In certain embodiments, the techniques described herein may be used to populate electronic financial forms, such as electronic invoices, bills, estimates, and/or receipts. An invoice form (simply referred to herein as an “invoice”) may indicate an itemized list of good(s) and/or service(s) sold along with their expected payment amount(s), due date(s), and/or term(s). A bill form (simply referred to herein as a “bill”) may be used to indicate an amount of money owed for good(s) supplied and/or service(s) rendered. An estimate form (simply referred to herein as an “estimate”) may be used to provide an approximation of a monetary amount to be either credited or debited, such as for item(s) that cannot be clearly measured. A receipt form (simply referred to herein as a “receipt”) may include information acknowledging the receipt of good(s), service(s), and/or money.

In certain embodiments, one or more form type classifications (simply referred to herein as “form type(s)”) may be assigned to an unstructured document to identify a type of electronic form to be populated, as well as a corresponding handler, LM, and schema to use for populating the electronic form. For example, an invoice classification may be assigned to an unstructured document to indicate that an electronic invoice should be automatically created for the unstructured document. A handler, associated with the creation of an electronic invoice, may be executed in response to assigning the invoice classification to the unstructured document. The handler may use an LM and a schema, associated with the electronic invoice, to extract information from the unstructured document and populate the electronic invoice. The schema may define the entities and structure associated with the electronic invoice, and thus guide the handler in the extraction and electronic invoice population. The handler, LM, and schema used in this example may be different than a handler, an LM, and a schema used to populate an electronic bill, an electronic estimate, and/or an electronic receipt, among others. As such, different classifications may be associated with different electronic forms and their corresponding handlers, LMs, and schemas, which are used to populate these electronic forms.

The data extraction and electronic form population techniques described herein thus provide significant technical advantages over conventional solutions, such as improved form population accuracy and processing speed, thus leading to better scalability for any process involving processing of forms. These technical effects overcome technical problems of low data extraction and data entry accuracy when populating electronic forms based on information extracted from unstructured documents, as well as limited data processing capabilities associated with manual data handling approaches. For example, the data extraction and form population techniques described herein automate data extraction and electronic form population, thereby reducing human errors and enhancing data reliability of created forms. Further, the data extraction and form population techniques described herein help to dramatically speed up processes for electronic form population, which were previously handled by humans in manual approaches. For example, with manual data extraction and form population, a user may spend approximately 166 seconds on average to manually obtain information and manually enter the information into an electronic form. With the techniques described herein, the data extraction and form population may be reduced by nearly 50 % (e.g., such as down to 90 seconds).

Use of an LM for data extraction from unstructured documents also provides further technical benefits. Automated techniques for data extraction and form population may struggle to handle unstructured documents and/or documents that require nuanced human understanding. An LM possesses the capability of NLP, which enables the LM to understand unstructured data regardless of format. For example, an LM may “understand” an unstructured document through (1) tokenization to break the text of the unstructured document into manageable pieces (e.g., referred to herein as tokens, which individual characters, words, sub-words, phrases, or even larger linguistic units in text), (2) embeddings to represent the meaning of the tokens in context, (3) self-attention to understand the relationships between the tokens, and (4) contextual representation to produce a representation for each token that is surrounded by its surrounding tokens. This allows the LM to disambiguate meanings based on context, understand structure, tone, and style of an unstructured document, as well as identify entities and relationships, especially in unstructured data. Further, the interaction of the LM with a schema helps to ensure that relevant information is identified and extracted from an unstructured document for the population of a particular electronic form (e.g., associated with the schema). That is, the schema helps to guide the LM to accurately identify and extract relevant data consistently from unstructured documents.

Notably, the improved data handling techniques described herein can further improve the function of any existing application that utilize electronic forms. For example, the techniques may be used to improve the speed and accuracy of data extraction from unstructured documents, which may in turn improve the speed and accuracy of populating electronic forms, which may be used by the application to perform subsequent tasks.

### Example System Implementing a Classification-Based Data Handling Service

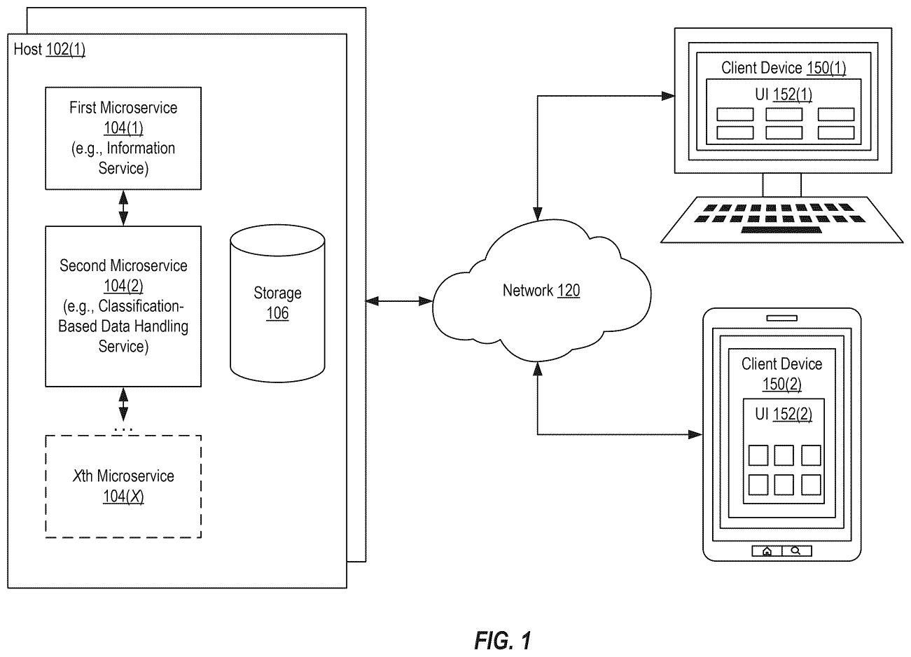

FIG. 1 depicts an example system 100 having a classification-based data handling service implemented as a software-defined service (e.g., in some cases, a cloud-native software-defined service), also referred to herein as “a microservice 104.” Generally, microservices 104 are loosely coupled and independently deployable services (or software) that may make up an application. Thus, microservices 104 may enable segmented, granular level functionalities within a larger system infrastructure. It should be understood that the components of system 100 depicted in FIG. 1 and described herein are merely examples and systems with additional, alternative, and/or a fewer number of components may be considered within the scope of this disclosure. For example, a classification-based data handling service may be implemented as something other than a microservice.

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform).

Client device 150(1) and client device 150(2) may each include a user interface (UI) 152(1), 152(2), respectively, which may be used to communicate with, at least, a first microservice 104(1) and a second microservice 104(2) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, the microservices 104 may include, at least, a first microservice 104(1) and a second microservice 104(2) (and up to an Xth microservice 104(X)). In certain embodiments, the first microservice 104(1) implements an information service, which is any network 120 accessible service that maintains financial data, medical data, personal identification data, and/or other data types. For example, the information service may include QuickBooks® and its variants made commercially available by Intuit® of Mountain View, California.

In certain embodiments, the second microservice 104(2) implements a classification-based data handling service. The classification-based data handling service may be a service used to perform, at least, automated information extraction and from population. In certain embodiments, the classification-based data handling service utilizes an LM to perform extraction. More specifically, the LM may be prompted to extract from one or more sources, such as documents (e.g., which may include structure and/or unstructured documents) stored and/or made available by the information service. In certain embodiments, the classification-based data handling service generates a structured output based on the extracted data. The structure output may be generated to be in compliance with a particular schema. For example, the schema may be associated with a particular, electronic form such as to facilitate the population of the electronic form including the extracted data.

In certain embodiments, the classification-based data handling service may summarize the structured output generated by the classification-based data handling service. The summarization and/or the structured output may be stored for future processing. For example, the summarization and/or the structured output may be analyzed to evaluate a performance of the information extraction service. In certain embodiments, the summarization may be displayed to a user, such as a convenience to the user, to indicate what document was processed and what electronic form was populated based on the processed document. For instance, an example summarization may state “the email from sender XXX on Nov. 25, 2024 was processed and used to generate an electronic invoice worth $1,000.”

In certain embodiments, the classification-based data handling service populates the electronic form (e.g., associated with the schema) based on the structured output. The classification-based data handling service may provide and/or make available the populated electronic form to first microservice 104(1), such that the electronic form may be displayed to a user of first microservice 104(1). For example, in certain embodiments, the information service implemented via first microservice 104(1) may be configured to generate the electronic form for display on client device 150(1) and/or client device 150(2), via user interface 152(1) and user interface 152(2), respectively. Display of the electronic form on client device 150(1) and/or client device 150(2) may allow a user to review the electronic form. In certain embodiments, the information may additionally prompt a user to provide information missing in the electronic form.

In certain embodiments, the information service implemented via first microservice 104(1) is configured to process the electronic form for performing one or more subsequent tasks. For example, where the generated electronic form is a bill (e.g., such as for goods and/or services previously provided to a user) then the information service may be configured to proceed with payment of the bill. As another example, where the generated electronic form is an invoice, then the information service may be configured to generate an email including the invoice and send the invoice to an individual expected to pay for the good(s) and/or service(s) identified in the invoice.

In certain embodiments, the information service implemented via the first microservice 104(1) may be configured to store the populated electronic form, such as for recordkeeping.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed.

### Example Workflow for Classification-Based Data Handling

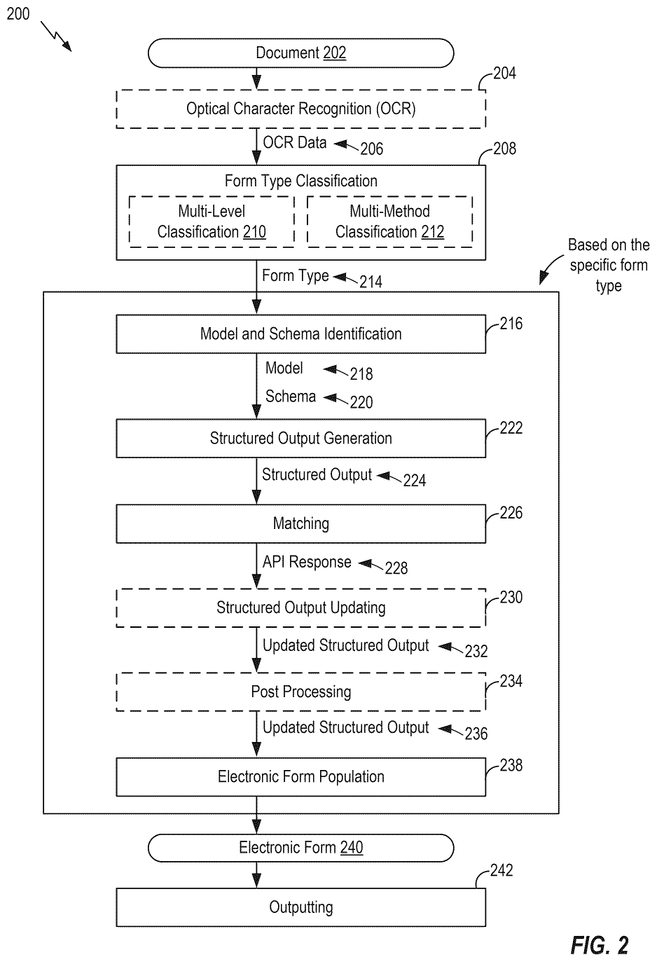

FIG. 2A depicts an example workflow 200 for classification-based data handling. More specifically, workflow 200 may be used to extract data from a document and populate an electronic form based on the extracted data. The type of electronic form that is populated, as well as a handler, LM, and schema used to perform the extraction and form population, may be based on a form type classification initially assigned to the document. An example electronic form generated via workflow 200 may include an electronic invoice, an electronic bill, an electronic estimate, or an electronic receipt.

Although workflow 200 describes the extraction of data from a single document, in other examples, workflow 200 may be used to extract data from multiple documents and/or other source(s) of structured or unstructured data. Further, although workflow 200 describes the population of a single electronic form, in other examples, workflow 200 may be used to populate multiple electronic forms from the extracted data. Additionally, it is noted that the aforementioned types of electronic forms that may be populated via workflow 200 are only example electronic form types, and other electronic form types may be similarly populated.

As shown in FIG. 2, workflow 200 begins by obtaining a document 202. In certain embodiments, document 202 may be an unstructured document, or a document lacking a predefined structure or format (e.g., as described above). Example unstructured documents may include text documents (e.g., letters, memos, reports, or essays that do not follow a specific schema), images, audio files, video files, social media posts, emails (e.g., while emails may generally include a subject, data, and sender, the body of the email may vary widely in format), sensor data, and/or the like. In certain embodiments, document 202 may be a structured document, or a document a document with a predefined format, where the layout, type of fields, and/or number of fields included in the document is consistent (e.g., as described above). Example structured documents may include forms (e.g., such as electronic forms), spreadsheets, JSON documents, XML documents, and/or the like.

In certain embodiments, document 202 represents a hard copy or a soft copy (e.g., without recognized text) of a document. Thus, to begin workflow 200, in certain embodiments, document 202 is scanned to generate a digital version of document 202 that may be processed by workflow 200. In certain embodiments, a photograph of document 202 may be taken and uploaded for processing via workflow 200. In some cases, the scan or photo is captured by a user's mobile device either indirectly (e.g., via a scanning or camera application), or within a native application running on the mobile device for which the extracted information is meant to be used. For example, in certain embodiments, a camera application is used to scan a quick response (QR) code associated with document 202. Based on scanning the QR code, the user's mobile device may be re-directed to a website or file folder containing the associated document 202. Further, other suitable methods for obtaining a digital copy of document 202 may be performed.

In certain other embodiments, document 202 includes text copied and pasted into a user interface of an application by a user of the application; text from an email; or a document imported form an external source, such as example online file sharing applications.

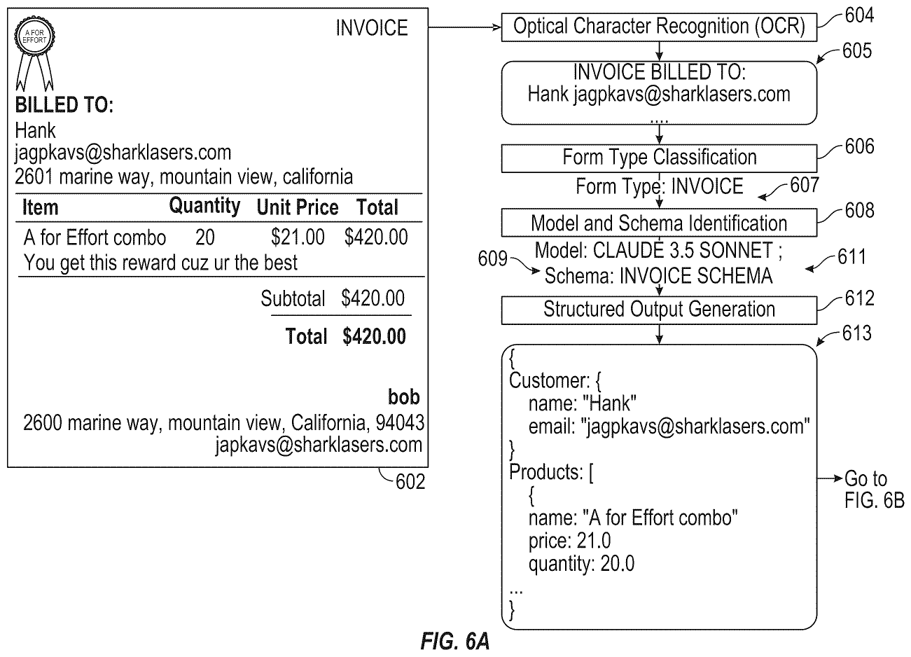

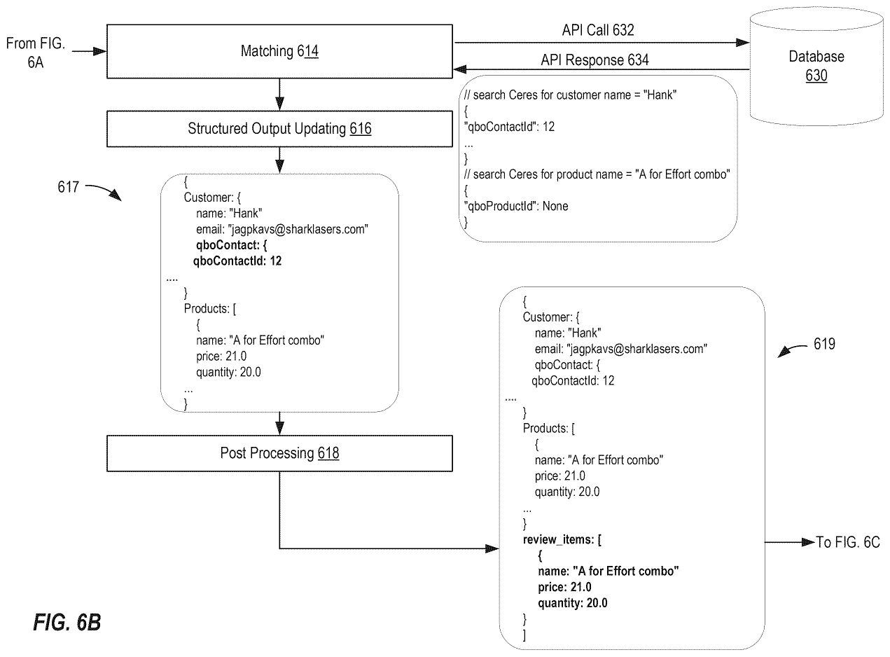

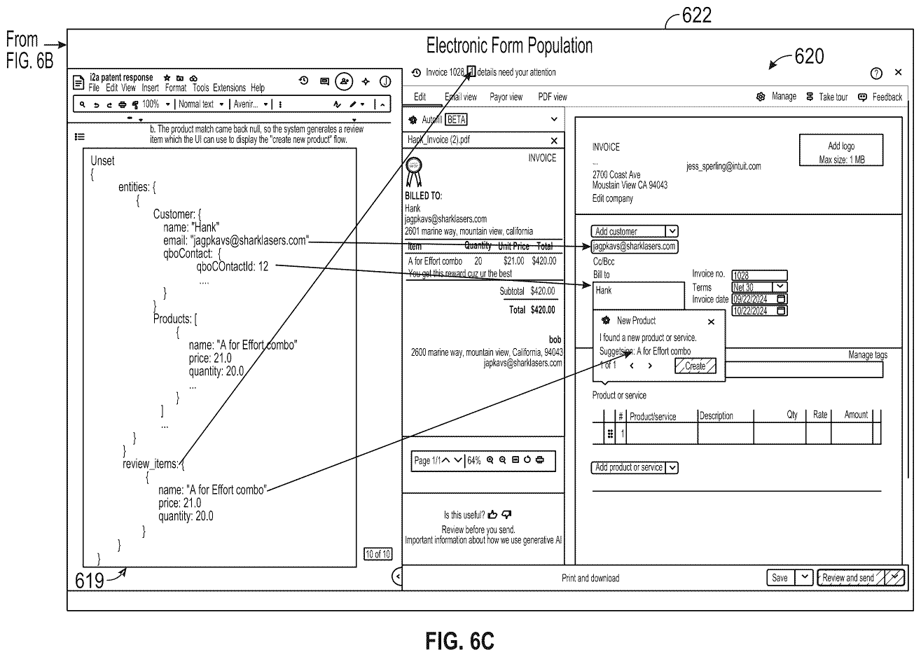

In certain embodiments, workflow 200 optionally proceeds with optical character recognition (OCR) 204 after obtaining document 202. OCR 204 includes performing OCR on document 202 to generate OCR data 206 for use in an application. For example, OCR 204 may include processing document 202 by locating and recognizing tokens (e.g., such as individual characters in text) and/or other characters, such as letters, numbers, and/or symbols. OCR 204 may then further include converting the recognized tokens and/or characters to a machine-readable text format (e.g., OCR data 206) that may be understood, for example, by an LM. The OCR data 206 generated based on document 202 may include raw text from document 202. Further, in certain embodiments, the OCR data 206 may include geometric information associated with document 202. The geometric information may include information about the positions of different tokens and/or other characters in document 202. Example OCR data 206 generated for document 202 is depicted in FIG. 6A.

Workflow 200 then proceeds with form type classification 208, which involves assigning a form type classification to the document 202, and more specifically determining a form type 214 of document 202. For example, in certain embodiments, document 202 may be classified as an invoice, a bill, an estimate, or a receipt (e.g., example form types 214) in an unstructured form.

Form type classification 208 may be performed using an LM (e.g., in some cases, a fine-tuned LM), a classification model, a classical artificial intelligence (AI) model, and/or one or more regular expressions (regex) rules. A classification model is a model trained to predict the correct label of a given input data, such as the form type 214 of document 202. A regex is a sequence of characters that can be used as a search pattern. Regex rules may be used to search for specific patterns in document 202 by using a syntax that includes metacharacters, quantifiers, and/or special characters, such as to determine the form type 214 of document 202. In certain embodiments, regex rules may be used based on a token (e.g., word) order of document 202 to classify document 202. For example, based on one rule, if the token “invoice” appears before the token “estimate” in the document 202, then the document 202 may be classified as an invoice. As another example, based on another rule, if the token “estimate” appears anywhere in the document 202 then the document 202 may be classified as an estimate. A classical AI model may be used as an option for form type classification 208 where training data is gathered with sample labeled documents, with logistic regression being used to classify.

In certain embodiments where OCR data 206 is generated for document 202, then form type classification 208 may leverage OCR data 206 when determining a form type 214 of document 202.

In certain embodiments, form type classification 208 may leverage an LM to determine a form type 214 of document 202. For example, one or more prompts may be generated and used to prompt the LM to classify document 202 and assign a form type 214 to document 202. In certain embodiments, the LM may also use metadata associated with document 202 (e.g., an associated company, an associated customer, etc.) to classify document 202 and assign the form type 214 to document 202.

An example prompt that may be used to prompt the LM includes:
Classify this document as: bill, invoice, receipt, or estimate.
RULES:
1. RECEIPT:
   The business, {company_name} or {owner_name} is the customer
   Shows payment already made
   Final balance is $0 or marked as paid
2. INVOICE:
   The business, {company_name} or {owner_name} is the seller
   Shows amount to be paid
   No payment applied yet
3. BILL:
   The business, {company_name} or {owner_name} is paying for products or services
   Shows amount to be paid
   No payment applied yet
4. ESTIMATE:
   The business, {company_name} or {owner_name} is providing an estimate for products or services
   Uses word “estimate” or “quote”
   No payment requested
STEPS:
1. Find out who is the seller or who is getting paid. Look at: Issue Check to, Pay to, Send Payment to, payable to etc.
2. Find who is the customer or who is paying. Look at: Bill to, Deliver to, Ship to, etc.
3. Check if payment was made
4. Look for words like “estimate” or “quote”
5. Check total amount and if it's paid
IMPORTANT:
   {company_name} or {owner_name} can be buyer or seller
   All parts of a rule must be true to use it
   If no rule fits, its ‘unclassified’
BUSINESS:
   Name: {company_name}
   Address: {company_address}
   Owner: {owner_name}
CONTENT:
{content}
″″″
   The data within the curly braces may include dynamic content, which may be filled in at run time.

In certain embodiments, form type classification 208 may include performing multi-level classification 210, which involves performing at least two levels of classification (e.g., main class classification and sub-class classification). For example, first, document 202 may be classified into one of a set number of main classes. Second, document 202 may be classified into one of a set number of sub-classes of the main class assigned to document 202. As used herein, a “main class” may refer to a primary category or a most general level of form type classification, while a “sub-class” may be a more specific category, or form type classification, that falls under the main class, essentially creating a hierarchy where the sub-class inherits characteristics from the main class.

As an illustrative example, first, document 202 may be classified into an invoice/estimate main class (e.g., an example first main class, which may deal with “brining money in”) or a bill/receipt main class (e.g., an example second main class, which may deal with “sending money out”). In certain embodiments, this main class classification may be performed using a classical AI logistic regression model running within a distributed, cloud-based model execution platform.

After the main class classification, one or more regex rules may be used to further delineate between subclasses of the identified main class. For example, regex rule(s) may be used to classify the document 202 as an invoice or an estimate where document 202 is first classified as invoice/estimate. Thus, a form type 214 assigned to document 202 may be either an invoice or an estimate. Alternatively, regex rule(s) may be used to classify the document 202 as a bill or a receipt where document 202 is first classified as a bill/receipt. Thus, a form type 214 assigned to document 202 may be either a bill or a receipt.

In certain embodiments, form type classification 208 may include performing multi-method classification 212, which involves using multiple methods for form type classification 208. In such cases, a majority form type assigned to document 202 among the different methods may be the final form type 214 assigned to document 202. In some other cases, only one method is used to determine the final form type 214 of document 202, while the other method(s) are used to perform classification 208, but have no bearing on the final form type 214 assigned to document 202. For example, two methods may run in parallel for multi-method classification 208. A first of the two methods may be used to determine a form type 214 of document 202. A second of the two methods may be run in a “shadow mode” such that a form type is determined using the second method. This form type determined using the second method may be compared with the form type 214 determined using the first method, such as for evaluation purposes. As an illustrative example, a classical AI model (e.g., a first method), an LM using a “Prompt A” (e.g., a second method), and an LM using a “Prompt B” (e.g., a third method) may each be used to determine a form type 214 for a document 202. The form type 214 determined using each of these methods may be evaluated to determine which method (e.g., which model and/or prompt) is best for classifying this type of document 202.

In certain embodiments, the form type 214 assigned to document 202 may be used to determine a type of electronic form to populate via workflow 200. For example, where document 202 is classified as an invoice (e.g., a first example form type 214), then an electronic invoice may be populated with data extracted from document 202. As another example, where document 202 is classified as a bill (e.g., a second example form type 214), then an electronic bill may be populated with data extracted from document 202. As another example, where document 202 is classified as an estimate (e.g., a third example form type 214), then an electronic estimate may be populated with data extracted from document 202. As another example, where document 202 is classified as a receipt (e.g., a fourth example form type 214), then an electronic receipt may be populated with data extracted from document 202.

Data handling, and more specifically data extraction and electronic form population, may be different for different form types 214. Thus, different handlers (e.g., functions, methods, or blocks of code, etc.) may be executed to perform subsequent steps of workflow 200 including, for example, model and schema identification 216, structured output generation 222, matching 226, structured output updating 230 (e.g., optional), post processing 234 (e.g. optional), and electronic form population 238. Workflow 200 of FIG. 2 shows such steps, which may be performed based on executing a handler associated with the determined form type 214.

Model and schema identification 216 may include identifying a model 218 and a schema 220 associated with form type 214. That is, different models and schemas may be used by the different handlers to perform subsequent steps of workflow 200. For example, in certain embodiments, where the form type 214 of document 202 is an invoice or an estimate, then a Claude® 3.5 Sonnet model, made available by Anthropic of San Francisco, California, may be used, such as for structured output generation 224 (e.g., described in detail below). However, where the form type 214 of document 202 is a bill, then a GPT-4o model, made available by OpenAI of San Francisco, California, may be used, such as for structured output generation 224. It is noted, however, that some form types may use the same type of model.

In certain embodiments, the model 218 comprises an LM, such as an LLM. An LM is a type of ML model that supports NLP tasks, such as generating text, analyzing sentiments, answering prompts (e.g., specific instructions and/or requests posed in natural language) in a conversational manner, translating text from one language to another, and/or the like. LMs make it possible for software to “understand” typical human speech or written content and respond to it by, in some cases, generating human-understandable responses through natural language generation (NLG). As used herein, the difference between a simple language model and an LLM is generally based on size of the model (often measured in terms of trainable parameters). For example, an LM with 1-2 billion parameters may be relatively small and referred to as a “simple language model,” while an LM with greater than 100 billion parameters may be larger and referred to as a large language model. However, it is noted, that the number of parameters generally associated with a simple LM and an LLM may change over time (e.g., a year from now, the scales may be different). In sum, an LM is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Further, different schemas 220, associated with different form types 214, may define different entities and different structures associated with the different form types 214. For example, a first set of entities and a first structured may be defined in a first schema associated with invoices, while a second set of entities and a second structure may be defined in a second schema associated with bills. In some cases, the first set of entities and the second set of entities may include one or more of the same entities and/or one or more different entities.

Example entities defined in a schema 220 that is associated with invoices (e.g., example form type 214) may include a customer, a product, a discount rate, a currency, a payment method, a product name, product characteristics, a product type, a price, a quantity, a discount, a name of a purchaser, and/or an email of the purchaser, to name a few.

Example entities defined in a schema 220 that is associated with bills (e.g., example form type 214) may include a line item, a bill header, an issued date, an address of a client, a due date, payment terms, a name of a product, a name of a service, line item description, a stock keeping unit (SKU) number, a line item quantity, and/or a unit price, to name a few.

Example entities defined in a schema 220 that is associated with estimates (e.g., example form type 214) may include a customer, a product, an expiration date, an acceptance date, a discount rate, a currency, a payment method, a product name, product characteristics, a product type, a price, a quantity, a discount, a name of a purchaser, and/or an email of the purchaser, to name a few.

Example entities defined in a schema 220 that is associated with receipts (e.g., example form type 214) may include a payment date, a payment method, an account the payment was made from, payment terms, a reference number, a name of a product, a name of a service, a category of the line item, a line item description, a SKU number, a line item quantity, a unit price, a name of a payee, an email of the payee, and/or an address of the payee, to name a few.

After model and schema identification 216, workflow 200 proceeds with structured output generation 222. Structured output generation 222 may include (1) performing data extraction to extract data from document 202 (or the OCR data 206 generated for document 202) and (2) generating a structured output 224 based on the extracted data. In certain embodiments, the model 218 (e.g., the LM) identified during model and schema identification 216 may be used to perform structured output generation 222.

In certain embodiments, data extraction includes extracting a plurality of values for a plurality of entities from document 202 (or the OCR data 206 generated for document 202). The entities for which values are extracted may include entities defined in schema 220.

As an illustrative example, an invoice form type 214 may be assigned to document 202 during form type classification 208; thus, a schema 220 associated with invoice form type 214 may be identified during model and schema identification 216. In this example, schema may include entities, such as customer, product, and price (e.g., example entities associated with invoices). Data extraction may be used to extract values for a customer, a product, and a price included in document 202 (or included in the OCR data 206 generated for document 202). Data extraction may return a customer name of “John Doe” (e.g., a first example value), a product of “Large Pizza” (e.g., a second example value), and a price of “$10.50” (e.g., a third example value).

As described above, structured output generation 222 further includes using the extracted data to generate a structured output 224. For example, a structured output 224 may be generated based on the values extracted from document 202 (or the OCR data 206 generated for document 202). In certain embodiments, the structured output 224 is generated to comply with schema 220, such that it includes values for entities included in schema 220 that are organized in a particular matter and comply with rules, constraints, default values, and/or other properties of schema 220.

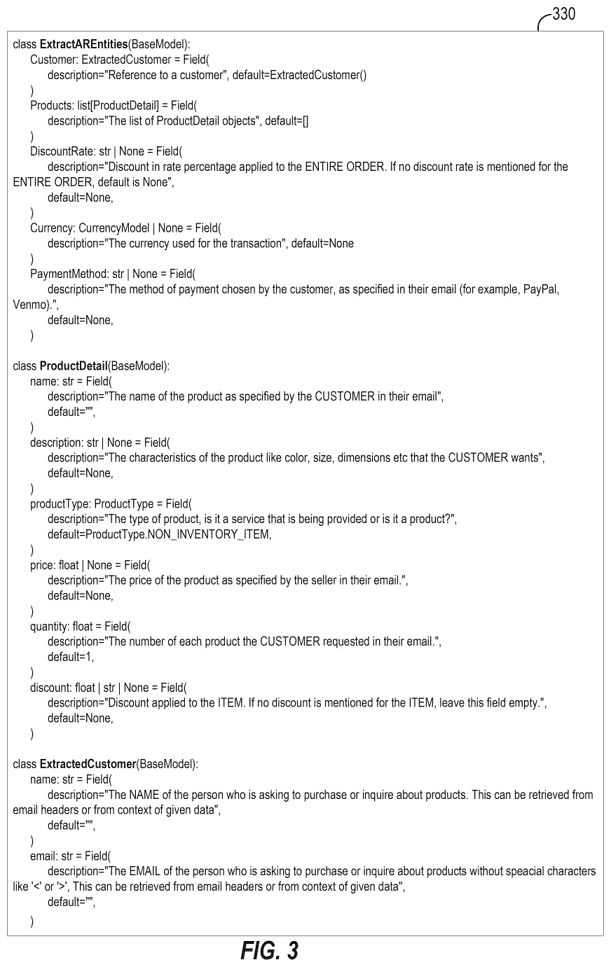

FIG. 3 depicts an example schema associated with an invoice form type (simply referred to herein as “invoice schema 330”). As shown in FIG. 3, invoice schema 330 includes entities, such as a customer, a product, a discount rate, a currency, a payment method, a product name, product characteristics, a product type, a price, a quantity, a discount, a name of a purchaser, and/or an email of the purchaser, which are associated with an invoice. Extracted values from a document or OCR data generated for the document, such as document 202 or OCR data 206 in FIG. 2, may be used to populate values for different entities in invoice schema 330, such as to create a structured output when the document is classified as an invoice and an electronic invoice (e.g., an electronic form) is to be populated, such as using workflow 200.

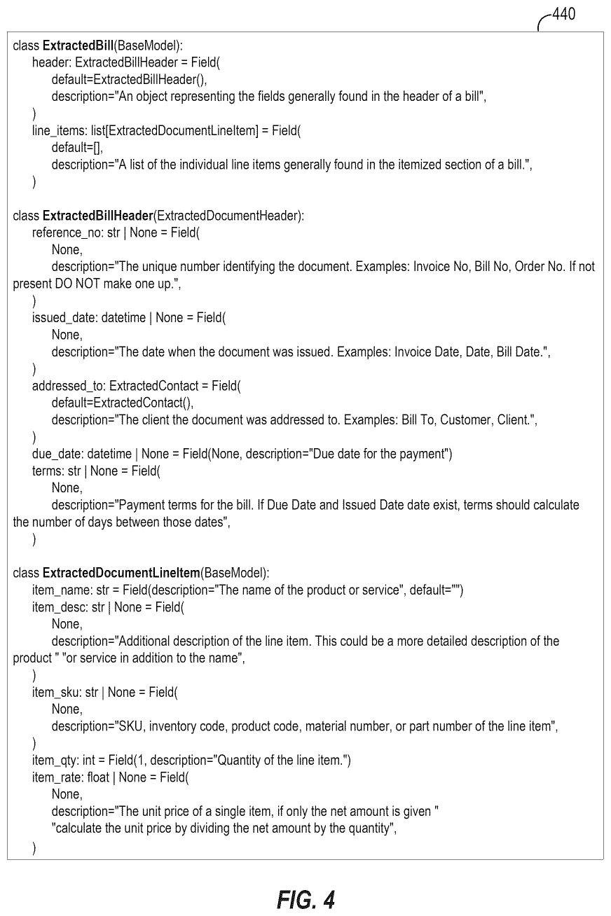

FIG. 4 depicts an example schema associated with a bill form type (simply referred to herein as “bill schema 440”). As shown in FIG. 4, bill schema 440 includes entities, such as a line item, a bill header, an issued date, an address of a client, a due date, payment terms, a name of a product, a name of a service, line item description, a stock keeping unit (SKU) number, a line item quantity, and/or a unit price, which are associated with a bill. Extracted values from a document or OCR data generated for the document, such as document 202 or OCR data 206 in FIG. 2, may be used to populate values for different entities in bill schema 440, such as to create a structured output when the document is classified as a bill and an electronic bill (e.g., an electronic form) is to be populated, such as using workflow 200.

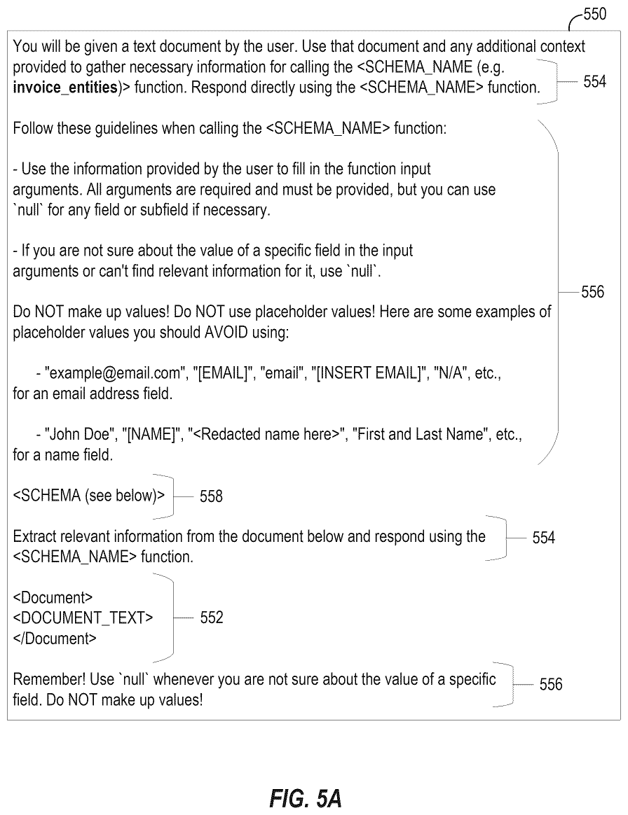

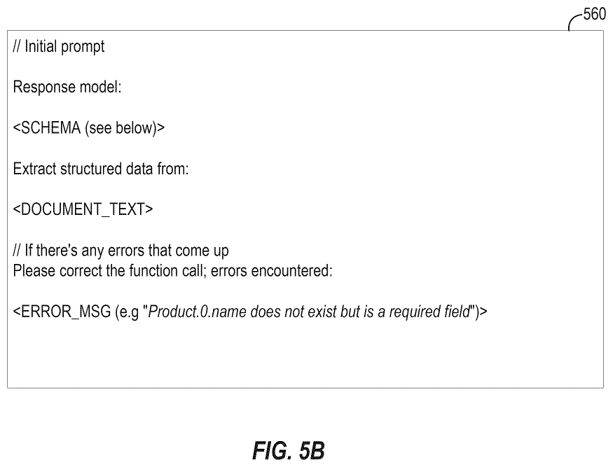

Returning to FIG. 2, in certain embodiments, structured output generation 222 is performed using the model 218 identified during model and schema identification 216. As described above, model 218 may be an example LM. Thus, structured output generation 222 may be performed based on prompting model 218 (e.g., the LM) to (1) extract values for entities included in document 202 (or the OCR data 206 generated for document 202) and (2) generate the structure output 224 based on the extracted values. FIGS. 5A and 5B depict example prompts that may be used to prompt a model, such as an LM, to perform structured output generation 222.

Specifically, FIG. 5A depicts an example single shot prompt 550 used to prompt an LM to perform structured output generation, such as structured output generation 222 in FIG. 2. As shown, example single shot prompt 550 includes (1) an indication of some OCR data generated for a document, shown at 552, (2) instructions to call a structured output function, shown at 554, (3) guidelines for calling the structured output function, shown at 556, and (4) an indication of the schema to use for generating a structured output, such as structured output 224 in FIG. 2, shown at 558. Calling the “structured output function” may trigger the generation of a structured output for the specified document, where the structured output is generated to be in compliance with the specified schema. It is noted that single shot prompt 550 is only one example and other single shot prompts used to prompt an LM to perform structured output generation may include more or less information that the information included in example single shot prompt 550. For example, in some cases, a single shot prompt 550 may additionally, or alternatively, include an indication of a desired output for the structured output, such as an indication that the schema should be in a JSON format.

FIG. 5B depicts an example iteration prompt 560 used to prompt an LM to perform structured output generation, such as structured output generation 222 in FIG. 2.

Returning to FIG. 2, in certain embodiments, a type of LM used to perform structured output generation 222 is based on the classification type assigned to document 202 during classification 208. For example, where document 202 is classified as an invoice, then a first type of LLM may be used; where document 202 is classified as a bill, then a second type of LLM may be used; where document 202 is classified as an estimate, then a third type of LLM may be used; and/or where document 202 is classified as a receipt, then a fourth type of LLM may be used. Some classification types may use the same type of LLM. For example, where document 202 is classified as an invoice or an estimate, then a Claude® 3.5 Sonnet model, made available by Anthropic of San Francisco, California, may be used for structured output generation 222. However, where document 202 is classified as a bill, then a GPT-4o model, made available by OpenAI of San Francisco, California, may be used for structured output generation 222.

The different models used for structured output generation 222 for different classification types may be selected based on the accuracy, latency, and/or cost associated with such models. For example, Claude 3.5 Sonnet and GPT-4o may provide more accurate results, such as in terms of extracting more fields, and performing this extraction with greater accuracy. As another example, with respect to latency, Claude 3.5 Sonnet may have less throughput and may be able to handle only a limited amount of traffic (e.g., ˜8 transaction a second). Due to this limitation, Clause 3.5 Sonnet may not be suitable for structured output generation 222 for bills, which generally have higher usage features (e.g., which may see greater than fifty transactions in a second). Thus, for bills, structured output generation 222 may rely on the use of other models, such as GPT-4o, which have more capacity.

After generating structured output 224, workflow 200 proceeds with matching 226. Matching 226 may include determining whether each value, extracted from document 202 (or the OCR data 206) and included in structured output 224 generated during structured output generation 222, matches any database value stored in a database.

For example, a database may include multiple database values. In certain embodiments, each database value may represent a possible value that may be extracted for an entity included in a schema (e.g., such as schema 220). In certain embodiments, each database value may represent a possible value that has been previously used in a structured output or a possible value that was added to the database by a user. As an illustrative example, twenty different database values may be created and stored in a database for a company that sells twenty different products. Put differently, one database value may be included in the database per product sold by the company. Each database value may include information about its corresponding product, such as a name of the product, a type of the product, a price of the product, a SKU number associated with the product, and/or other characteristics associated with the product. Further, each database value may include a respective identifier associated with each respective database value. These database values represent possible values that may be found in an invoice schema, such as for “a product” entity.

In certain embodiments, matching 226 may be performed to find exact matches between the extracted values and the database values included in the database. A database value may represent an exact match for an extracted value when the database value contains the exact same string value as the database value. A “string value,” as used herein, may generally refer to a string of letters, numbers, and/or characters. For example, a database value comprising the string value “iced coffee” may be an exact match of an extracted value also comprising the string value “iced coffee.” In certain embodiments, matching 226 may be performed to find “fuzzy” matches between the extracted values and the database values included in the database. Fuzzy matching is a techniques that identifies and matches data that is similar or partially matches, but is not identical. In certain embodiments, matching 226 may be performed to find matches between extracted values and the database values based on performing a semantic search, such as by calculating the embeddings for each extracted value and each database value and determining vector similarity between the embeddings.

In certain embodiments, matching 226 is performed based on making an application programming interface (API) request to a database service associated with the database. The API request may request the database service to identify whether there exists a database value that matches each extracted value for one or more of the extracted values included in structured output 224 (e.g., such as each of the extracted values for all extracted values included in structured output 224). In certain embodiments, one or more extracted values may be found to have matching database values. In such cases, the database service may respond to the API request with an API response 228 including a respective identifier associated with each matched database value (e.g., “Database ID: XXX”), and an indication of which extracted value each matched database value corresponds to. In certain embodiments, one or more extracted values may be found to not have any matching database values. In such cases, the database service may respond to the API request with an API response 228 including an indication that these extracted value(s) do not match any database value. For example, the API response 228 may include an indication of “Database ID: None” or “Database ID: Null.” In certain embodiments, a first subset of the extracted values may be found to have matching database values, while a second subset of the extracted values may be found not to have matching database values. In such cases, the database service may respond to the API request with an API response 228 including (1) a respective identifier associated with each database value matching the first subset of the extracted values, as well as an indication of which extracted value each matched database value corresponds to and (2) an indication that the second subset of the extracted values do not match any database value. An example API response 228 is depicted and described below with respect to FIG. 6B.

Workflow 200 then optionally proceeds with structured output updating 230, which may be used to update the structured output 224 (e.g., generated during structured output generation 222) based on the API response 228 received from the database service, such as to generate updated structured output 232. For example, for each extracted value matching a database value, the structured output 224 may be updated to include the respective identifier for the matched database value. During structured output updating 230, no updates may be made to extracted values in the structured output 224 for which no database value match exists. Thus, in cases where none of the extracted values are identified to match any of the database values, then structured output updating 230 may not be performed to generate updated structured output 232.

Workflow 200 may then optionally proceed with post processing 234, which may be used to generate a respective review item for each extracted value that does not match any database value included in the database. Put differently, post processing 234 may be used to generate a respective review item for each extracted value, included in structured output 224, that does not match any database values included in the database (e.g., based on API response 228). Each review item may be added to the structured output 224 (or updated structured output 232, where structure output updating 230 is performed) to generate updated structured output 236. Adding the review items to structured output 224 (or updated structured output 232) may cause a user to be prompted to provide additional information for each extracted value for which a review item is created in the updated structured output 236. Specifically, this prompting may occur during electronic form population 238, described in detail below. For example, a review item may be created for an extracted value “iced coffee” because an “iced coffee” database value does not exist in the database. The review item may be added to structured output 224 (or updated structured output 236) and used to prompt a user to provide additional information about the “iced coffee” value (e.g., such as a product type, a price, and/or other characteristics) during electronic form population 238.

Workflow 200 then proceeds with electronic form population 238 to populate an electronic form 240 based on updated structured output 232 or updated structured output 236. The electronic form 240 that is populated during electronic form population 238 may be based on the form type 214 assigned to document 202 during form type classification 208. For example, electronic form 240 may comprise an electronic invoice where document 202 is determined to be an invoice form type. Populating electronic form 240 may include filling in fields of the electronic form 240 based on the information, such as the extracted values, included in updated structured output 232 or updated structured output 236. In certain embodiments, an identifier of a database value associated with an extracted value and included in updated structured output 232 may be used to retrieve additional information about the extracted value from the database such that it can be added to the form template. For example, updated structured output 232 may include an indication of an identifier “Database ID: 12” for an extracted value “John Doe.” Using database ID 12, additional information associated with extracted value “John Doe” may be retrieved from the database. This additional information may include, for example, John Doe's address, age, gender, marital status, etc. Some or all of this additional information may be used to populate electronic form 240.

As described above, in certain embodiments, electronic form population 238 includes prompting a user based on one or more review items included in updated structured output 236. A user may be prompted to provide additional information about one or more extracted values included in updated structured output 236. Additional information received from a user about the one or more extracted values may be used to populate electronic form 240, and further in some cases, generate a matching database value, in the database, for each extracted value for which additional information is received.

Workflow 200 then proceeds with outputting 224 to provide as output electronic form 240. For example, in certain embodiments, electronic form 240 may be provided as output and/or made available for use. In certain embodiments, electronic form 240 may be displayed to a user, such a via a user interface. In certain embodiments, electronic form 240 may be processed for performing one or more subsequent tasks. For example, where the generated electronic form 240 is a bill, then a subsequent task may include payment of the bill. As another example, where the generated electronic form 240 is an invoice, then a subsequent task may include generating an email including the invoice (e.g., the electronic form 240), and sending the invoice to an individual associated with the invoice and the email.

### Example Classification-Based Data Handling for Electronic Form Population

FIGS. 6A-5C depict example electronic form population 600 (simply referred to herein as “population 600”), such as the population of an electronic invoice 620 (e.g., shown in FIG. 6C) from unstructured data. Electronic form population 600 may use workflow 200, depicted and described above with respect to FIG. 2, for populating the electronic invoice 620.

Population 600 begins by obtaining a document 602. In this example, document 602 is an image of an invoice. The image of the invoice may be obtained based on a user taking and uploading a photo of the invoice for processing. The invoice shown in FIG. 6A, as document 302, provides an itemized list of 20 “A for Effort combo” rewards that are billed to a customer “Hank.”

Population 600 proceeds with OCR 604 (e.g., similar to OCR 204 in FIG. 2) to perform OCR on document 602 and thus generate OCR data 605.

Population 600 then proceeds with form type classification 606 (e.g., similar to form type classification 208 in FIG. 2) to assign a form type 607 to document 602. In this example, a form type 607 assigned to document 602 includes “Form Type: Invoice.” This form type 607 indicates that document 602 represents an invoice, and further that an electronic invoice, e.g., an example electronic form, is to be populated for document 602.

A handler associated with invoice form types may be used to perform the subsequent steps of population 600 shown in FIGS. 6A-6C. For example, the specific handler may perform model and schema identification 608, structured output generation 612, matching 614, structured output updating 616, post processing 618, and electronic form population 622 shown in FIGS. 6A-6C.

Model and schema identification 608 (e.g., similar to model and schema identification 216 in FIG. 2) may include identifying a model 609 and a schema 611 associated with form type 607. In this example, model 609 associated with “Form Type: Invoice” comprises a Claude® 3.5 Sonnet model. Further, in this example, schema 611 associated with “Form Type: Invoice” comprises an invoice schema.

Population 600 then proceeds with structured output generation 612 (e.g., similar to structured output generation 612 in FIG. 2) to (1) extract a plurality of values for a plurality of entities from OCR data 605 generated for document 602 and (2) generate a structured output 613 based on the extracted values. In this example, extracted values for an entity “Customer” include “Hank” and “jagpkavs@sharklasers.com.” Further, extracted values for an entity “Product” include “A for Effort combo,” “21.0” (e.g., representing the price), and “20.0” (e.g., representing the quantity). These extracted values are used to generate structured output 613. Structured output 613 may be generated to be in compliance with schema 611. In certain embodiments, structured output generation 612 may be performed using model 609.

Population 600 then proceeds with matching 614 in FIG. 6B (e.g., similar to matching 226 in FIG. 2). For example, an API call 632 is sent to a database service associated with a database 630, requesting the database service to identify any database values matching the extracted values in structured output 613. An API response 634 is produced in response to the API call 632. For this example, a match for extracted value “Hank” may be included in database 630, but a match for extracted value “A for Effort combo” may not be included in database 630. As such, API response 634 may include an identifier for the match of extracted value “Hank” (e.g., “qboContactId”: 12) and not include any identifier for extracted value “A for Effort combo” (e.g., “qboContactId”: None).

Population 600 then proceeds with structured output updating 616 (e.g., similar to structured output updating 230 in FIG. 2). Structured output updating 616 may be used to generate an updated structured output 617 from structured output 613. For example, structured output 613 may be updated to include the identifier for the match of extracted value “Hank” (e.g., “qboContactId”: 12), such as shown in updated structured output 617 in FIG. 6B.

Population 600 then proceeds with post processing 618 (e.g., similar to post processing 234 in FIG. 2). Post processing 618 may be used to create a review item for extracted value “A for Effort combo” given no match for this extracted value was found in database 630. This review item may be added to updated structured output 617 to further update the updated structured output 617 to updated structured output 619, shown in FIG. 6B.

Population 600 then proceeds with electronic form population 622 in FIG. 6C (e.g., similar to electronic form population 238 in FIG. 2). Electronic form population 238 may be used to populate the electronic invoice 620 (e.g., the example electronic form) based on updated structured output 619. Further, electronic form population 622 may be used to obtain additional information, from database 630, related to extracted value “Hank” and prompt a user to provide additional information about extracted value “A for Effort combo.” This additional information may be used to further populate the electronic invoice 620.

### Example Method for Classification-Based Data Handling

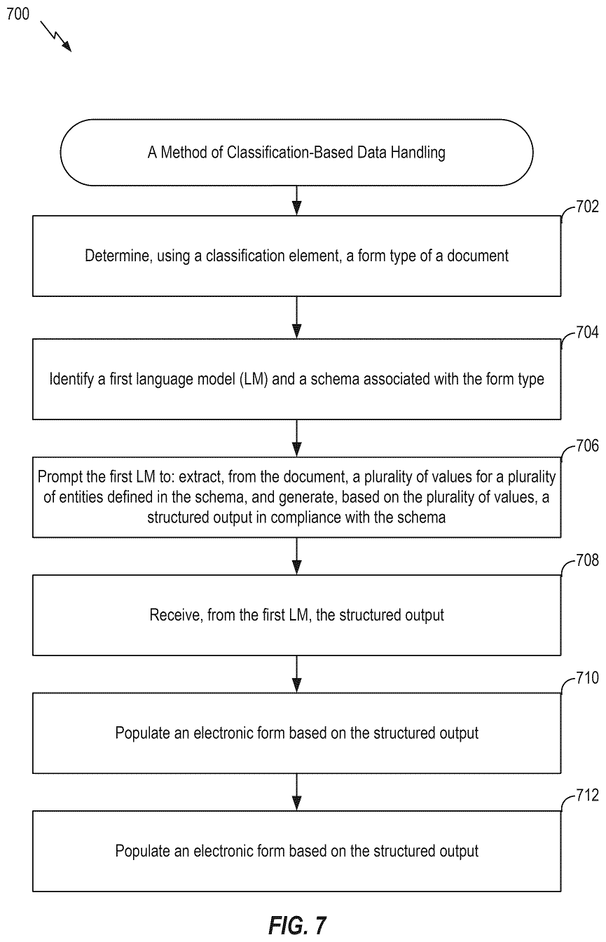

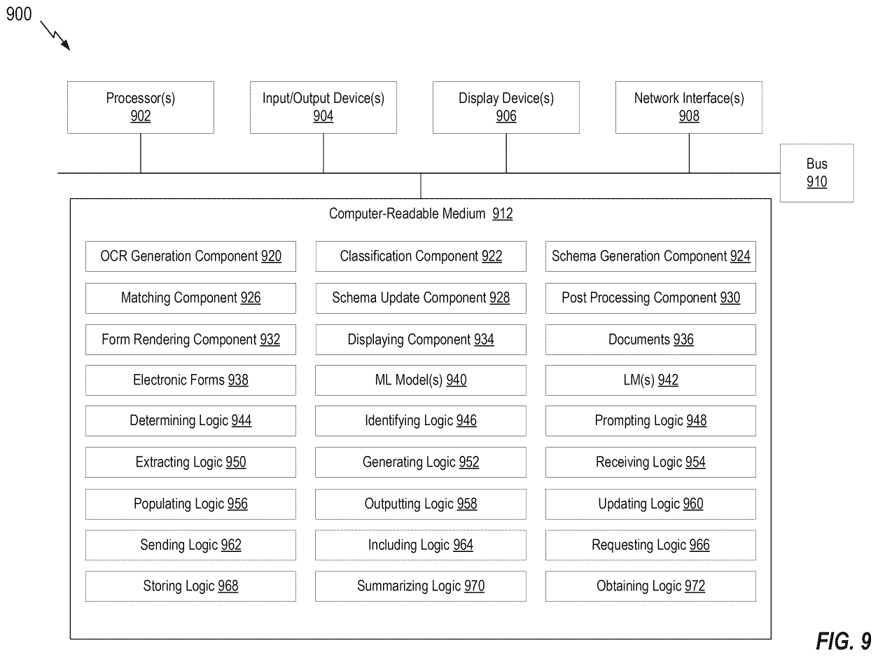

FIG. 7 depicts an example method 700 for classification-based data handling. In one aspect, method 700 can be implemented by the processing system 900 of FIG. 9.

Method 700 starts, at block 702, with determining, using a classification element, a form type of a document.

Method 700 continues, to block 704, with identifying a first language model (LM) and a schema associated with the form type.

Method 700 continues, to block 706, with prompting the first LM to: extract, from the document, a plurality of values for a plurality of entities defined in the schema, and generate, based on the plurality of values, a structured output in compliance with the schema.

Method 700 continues, to block 708, with receiving, from the first LM, the structured output.

Method 700 continues, to block 710, with populating an electronic form based on the structured output.

Method 700 continues, to block 712, with outputting the electronic form.

In certain embodiments, method 700 further includes updating the structured output based on determining whether each value of the plurality of values included in the structured output matches any database value of a plurality of database values stored in a database.

In certain embodiments, updating the schema based on determining whether each value of the plurality of values included in the structured output matches any database value comprises: determining at least one value of the plurality of values included in the structured output matches a database value of the plurality of database values; and updating the structured output to include an identifier associated with the database value.

In certain embodiments, determining the at least one value of the plurality of values included in the structured output matches the database value comprises: sending, to a database service associated with the database, an application programming interface (API) request to identify whether the at least one value of the plurality of values included in the structured output matches any database value; and receiving, from the database service, via an API response, the identifier associated with the database value that matches the at least one value of the plurality of values.

In certain embodiments, updating the schema based on determining whether each value of the plurality of values included in the structure output matches any database value comprises: determining at least one value of the plurality of values included in the structure output does not match any database value of the plurality of database values; and updating the structured output to indicate that the at least one value does not match any database value.

In certain embodiments, determining the at least one value of the plurality of values included in the structured output does not match any database value comprises: sending, to a database service associated with the database, an API request to identify whether the at least one value of the plurality of values included in the structured output matches any database value; and receiving, from the database service, via an API response, an indication that the at least one value of the plurality of values included in the structured output does not match any database value.

In certain embodiments, method 700 further includes including, in the structured output, a review item for the at least one value.

In certain embodiments, populating the electronic form based on the structured output comprises: requesting a user to provide information about the at least one value; receiving the information from the user; and populating the electronic form further based on the information.

In certain embodiments, the classification element comprises: a classification model; a second LM; or one or more regular expression rules.

In certain embodiments, the form type comprises an invoice, the electronic form comprises an electronic invoice, and the plurality of entities comprise at least one of a customer, a product, a discount rate, a currency, a payment method, a product name, product characteristics, a product type, a price, a quantity, a discount, a name of a purchaser, or an email of the purchaser.

In certain embodiments, the form type comprises a bill, the electronic form comprises an electronic bill, and the plurality of entities comprise at least one of a line item, a bill header, an issued date, an address of a client, a due date, payment terms, a name of a product, a name of a service, line item description, a stock keeping unit (SKU) number, a line item quantity, or a unit price.

In certain embodiments, the form type comprises an estimate, the electronic form comprises an electronic estimate, and the plurality of entities comprise at least one of a customer, a product, an expiration data, an acceptance date, a discount rate, a currency, a payment method, a product name, product characteristics, a product type, a price, a quantity, a discount, a name of a purchaser, and/or an email of the purchaser, to name a few.

In certain embodiments, the form type comprises a receipt, the electronic form comprises an electronic receipt, and the plurality of entities comprise at least one of a payment date, a payment method, an account the payment was made from, payment terms, a reference number, a name of a product, a name of a service, a category of the line item, a line item description, a SKU number, a line item quantity, a unit price, a name of the payee, an email of the payee, and/or an address of the payee, to name a few.

In certain embodiments, the LM is prompted based on a prompt comprising: an indication of the document; instructions to call a structured output function; guidelines for calling the structured output function; and an indication of the schema.

In certain embodiments, the prompt further comprises an output format for the structured output.

In certain embodiments, method 700 further includes generating optical character recognition (OCR) data for the document, wherein prompting the first LM to extract, from the document, the plurality of values comprises prompting the first LM to extract, from the OCR data, the plurality of values.

In certain embodiments, method 700 further includes prompting a second LM to generate a summary for the structured output; and storing the summary in a repository.

Note that FIG. 7 is just one example of a method, and other methods including fewer, additional, or alternative operations are possible consistent with this disclosure.

### Example Method for Data Handling

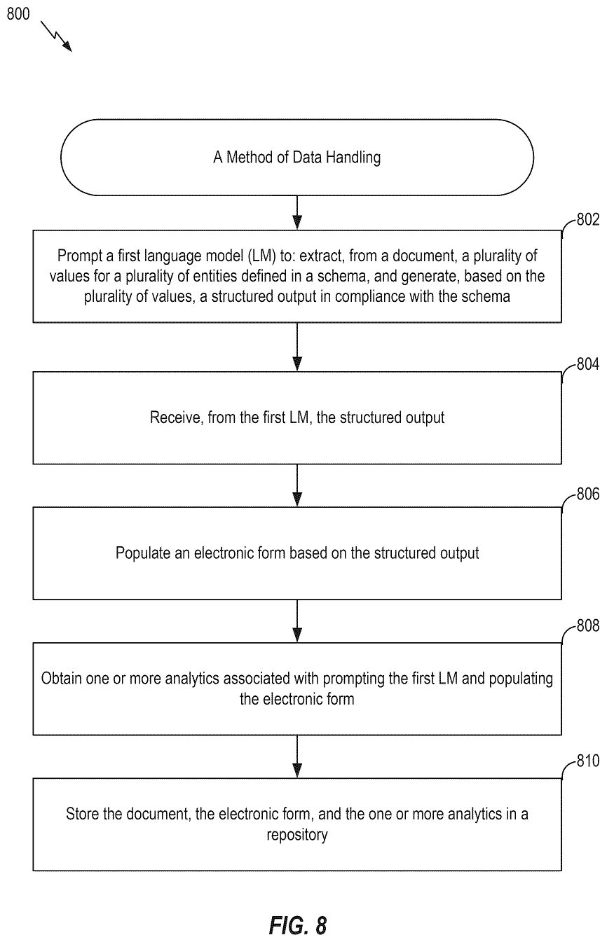

FIG. 8 depicts an example method 800 for data handling. In one aspect, method 800 can be implemented by the processing system 900 of FIG. 9.

Method 800 starts, at block 802, with prompting a first language model (LM) to extract, from a document, a plurality of values for a plurality of entities defined in a schema; and generate; based on the plurality of values, a structured output in compliance with the schema.

Method 800 continues, to block 804, with receiving, from the first LM, the structured output.

Method 800 continues, to block 806, with populating an electronic form based on the structured output.

Method 800 continues, to block 808, with obtaining one or more analytics associated with prompting the first LM and populating the electronic form.

Method 800 continues, to block 810, with storing the document, the electronic form, and the one or more analytics in a repository.

In certain embodiments, method 800 further includes updating the structured output based on determining whether each value of the plurality of values included in the structured output matches any database value of a plurality of database values stored in a database.

In certain embodiments, updating the schema based on determining whether each value of the plurality of values included in the structured output matches any database value comprises: determining at least one value of the plurality of values included in the structured output matches a database value of the plurality of database values; and updating the structured output to include an identifier associated with the database value.

In certain embodiments, determining the at least one value of the plurality of values included in the structured output matches the database value comprises: sending, to a database service associated with the database, an application programming interface (API) request to identify whether the at least one value of the plurality of values included in the structured output matches any database value; and receiving, from the database service, via an API response, the identifier associated with the database value that matches the at least one value of the plurality of values.

In certain embodiments, updating the schema based on determining whether each value of the plurality of values included in the structure output matches any database value comprises: determining at least one value of the plurality of values included in the structure output does not match any database value of the plurality of database values; and updating the structured output to indicate that the at least one value does not match any database value.

In certain embodiments, determining the at least one value of the plurality of values included in the structured output does not match any database value comprises: sending, to a database service associated with the database, an API request to identify whether the at least one value of the plurality of values included in the structured output matches any database value; and receiving, from the database service, via an API response, an indication that the at least one value of the plurality of values included in the structured output does not match any database value.

In certain embodiments, method 800 further includes including, in the structured output, a review item for the at least one value.

In certain embodiments, populating the electronic form based on the structured output comprises: requesting a user to provide information about the at least one value; receiving the information from the user; and populating the electronic form further based on the information.

In certain embodiments, method 800 further includes determining, using a classification element, a form type of the document; and based on the form type, identifying the first LM and the schema.

In certain embodiments, the classification element comprises: a classification model; a second LM; or one or more regular expression rules.

In certain embodiments, the form type comprises an invoice, the electronic form comprises an electronic invoice, and the plurality of entities comprise at least one of a customer, a product, a discount rate, a currency, a payment method, a product name, product characteristics, a product type, a price, a quantity, a discount, a name of a purchaser, or an email of the purchaser.

In certain embodiments, the form type comprises a bill, the electronic form comprises an electronic bill, and the plurality of entities comprise at least one of a line item, a bill header, an issued date, an address of a client, a due date, payment terms, a name of a product, a name of a service, line item description, a stock keeping unit (SKU) number, a line item quantity, or a unit price.

In certain embodiments, the form type comprises an estimate, the electronic form comprises an electronic estimate, and the plurality of entities comprise at least one of include a customer, a product, an expiration date, an acceptance date, a discount rate, a currency, a payment method, a product name, product characteristics, a product type, a price, a quantity, a discount, a name of a purchaser, and/or an email of the purchaser, to name a few.

In certain embodiments, the form type comprises a receipt, the electronic form comprises an electronic receipt, and the plurality of entities comprise at least one of a payment date, a payment method, an account the payment was made from, payment terms, a reference number, a name of a product, a name of a service, a category of the line item, a line item description, a SKU number, a line item quantity, a unit price, a name of a payee, an email of the payee, and/or an address of the payee, to name a few.

In certain embodiments, the LM is prompted based on a prompt comprising: an indication of the document; instructions to call a structured output function; guidelines for calling the structured output function; and an indication of the schema.

In certain embodiments, the prompt further comprises an output format for the structured output.

In certain embodiments, method 800 further includes generating optical character recognition (OCR) data for the document, wherein prompting the first LM to extract, from the document, the plurality of values comprises prompting the first LM to extract, from the OCR data, the plurality of values.

Note that FIG. 8 is just one example of a method, and other methods including fewer, additional, or alternative operations are possible consistent with this disclosure.

### Example Processing System for Electronic Form Generation

FIG. 9 depicts an example processing system 900 configured to perform various aspects described herein, including, for example, method 700 as described above with respect to FIG. 7 and/or method 800 as described above with respect to FIG. 8.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output devices 904, one or more display devices 906, one or more network interfaces 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain embodiments, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various embodiments, display device(s) 916 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes OCR generation component 920, classification component 922, schema generation component 924, matching component 926, schema update component 928, post processing component 930, form rendering component 932, displaying component 934, documents 936, electronic forms 938, ML model(s) 940, LM(s) 942, determining logic 944, identifying logic 946, prompting logic 948, extracting logic 950, generating logic 952, receiving logic 954, populating logic 956, outputting logic 958, updating logic 960, sending logic 962, including logic 984, requesting logic 966, storing logic 968, summarizing logic 970, and obtaining logic 972.

Note that FIG. 9 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method of classification-based data handling, comprising: determining, using a classification element, a form type of a document; identifying a first language model (LM) and a schema associated with the form type; prompting the first LM to: extract, from the document, a plurality of values for a plurality of entities defined in the schema, and generate, based on the plurality of values, a structured output in compliance with the schema; receiving, from the first LM, the structured output; populating an electronic form based on the structured output; and outputting the electronic form.

Clause 2: The method of Clause 1, further comprising: updating the structured output based on determining whether each value of the plurality of values included in the structured output matches any database value of a plurality of database values stored in a database.

Clause 3: The method of Clause 2, wherein updating the schema based on determining whether each value of the plurality of values included in the structured output matches any database value comprises: determining at least one value of the plurality of values included in the structured output matches a database value of the plurality of database values; and updating the structured output to include an identifier associated with the database value.

Clause 4: The method of Clause 3, wherein determining the at least one value of the plurality of values included in the structured output matches the database value comprises: sending, to a database service associated with the database, an application programming interface (API) request to identify whether the at least one value of the plurality of values included in the structured output matches any database value; and receiving, from the database service, via an API response, the identifier associated with the database value that matches the at least one value of the plurality of values.

Clause 5: The method of any one of Clauses 2-4, wherein updating the schema based on determining whether each value of the plurality of values included in the structure output matches any database value comprises: determining at least one value of the plurality of values included in the structure output does not match any database value of the plurality of database values; and updating the structured output to indicate that the at least one value does not match any database value.

Clause 6: The method of Clause 5, wherein determining the at least one value of the plurality of values included in the structured output does not match any database value comprises: sending, to a database service associated with the database, an API request to identify whether the at least one value of the plurality of values included in the structured output matches any database value; and receiving, from the database service, via an API response, an indication that the at least one value of the plurality of values included in the structured output does not match any database value.

Clause 7: The method of any one of Clauses 5-6, further comprising including, in the structured output, a review item for the at least one value.

Clause 8: The method of Clause 7, wherein populating the electronic form based on the structured output comprises: requesting a user to provide information about the at least one value; receiving the information from the user; and populating the electronic form further based on the information.

Clause 9: The method of any one of Clauses 1-8, wherein the classification element comprises: a classification model; a second LM; or one or more regular expression rules.

Clause 10: The method of any one of Clauses 1-9, wherein: the form type comprises an invoice, the electronic form comprises an electronic invoice, and the plurality of entities comprise at least one of a customer, a product, a discount rate, a currency, a payment method, a product name, product characteristics, a product type, a price, a quantity, a discount, a name of a purchaser, or an email of the purchaser.

Clause 11: The method of any one of Clauses 1-10, wherein: the form type comprises a bill, the electronic form comprises an electronic bill, and the plurality of entities comprise at least one of a line item, a bill header, an issued date, an address of a client, a due date, payment terms, a name of a product, a name of a service, line item description, a stock keeping unit (SKU) number, a line item quantity, or a unit price.

Clause 12: The method of any one of Clauses 1-11, wherein: the form type comprises an estimate, the electronic form comprises an electronic estimate, and the plurality of entities comprise at least one of a customer, a product, an expiration data, an acceptance date, a discount rate, a currency, a payment method, a product name, product characteristics, a product type, a price, a quantity, a discount, a name of a purchaser, or an email of the purchaser.

Clause 13: The method of any one of Clauses 1-12, wherein: the form type comprises a receipt, the electronic form comprises an electronic receipt, and the plurality of entities comprise at least one of a payment date, a payment method, an account a payment was made from, payment terms, a reference number, a name of a product, a name of a service, a category of a line item, a line item description, a SKU number, a line item quantity, a unit price, a name of a payee, an email of the payee, or an address of the payee.

Clause 14: The method of any one of Clauses 1-13, wherein the LM is prompted based on a prompt comprising: an indication of the document; instructions to call a structured output function; guidelines for calling the structured output function; and an indication of the schema.

Clause 15: The method of Clause 14, wherein the prompt further comprises an output format for the structured output.

Clause 16: The method of any one of Clauses 1-15, further comprising: generating optical character recognition (OCR) data for the document, wherein prompting the first LM to extract, from the document, the plurality of values comprises prompting the first LM to extract, from the OCR data, the plurality of values.

Clause 17: The method of any one of Clauses 1-16, further comprising: prompting a second LM to generate a summary for the structured output; and storing the summary in a repository.

Clause 18: A method of data handling, comprising: prompting a first language model (LM) to: extract, from a document, a plurality of values for a plurality of entities defined in a schema; and generate; based on the plurality of values, a structured output in compliance with the schema; receiving, from the first LM, the structured output; populating an electronic form based on the structured output; obtaining one or more analytics associated with prompting the first LM and populating the electronic form; and storing the document, the electronic form, and the one or more analytics in a repository.

Clause 19: The method of Clause 18, further comprising: updating the structured output based on determining whether each value of the plurality of values included in the structured output matches any database value of a plurality of database values stored in a database.

Clause 20: The method of Clause 19, wherein updating the schema based on determining whether each value of the plurality of values included in the structured output matches any database value comprises: determining at least one value of the plurality of values included in the structured output matches a database value of the plurality of database values; and updating the structured output to include an identifier associated with the database value.

Clause 21: The method of Clause 20, wherein determining the at least one value of the plurality of values included in the structured output matches the database value comprises: sending, to a database service associated with the database, an application programming interface (API) request to identify whether the at least one value of the plurality of values included in the structured output matches any database value; and receiving, from the database service, via an API response, the identifier associated with the database value that matches the at least one value of the plurality of values.

Clause 22: The method of any one of Clauses 19-21, wherein updating the schema based on determining whether each value of the plurality of values included in the structure output matches any database value comprises: determining at least one value of the plurality of values included in the structure output does not match any database value of the plurality of database values; and updating the structured output to indicate that the at least one value does not match any database value.

Clause 23: The method of Clause 22, wherein determining the at least one value of the plurality of values included in the structured output does not match any database value comprises: sending, to a database service associated with the database, an API request to identify whether the at least one value of the plurality of values included in the structured output matches any database value; and receiving, from the database service, via an API response, an indication that the at least one value of the plurality of values included in the structured output does not match any database value.

Clause 24: The method of any one of Clauses 22-23, further comprising including, in the structured output, a review item for the at least one value.

Clause 25: The method of Clause 24, wherein populating the electronic form based on the structured output comprises: requesting a user to provide information about the at least one value; receiving the information from the user; and populating the electronic form further based on the information.

Clause 26: The method of any one of Clauses 18-25, further comprising: determining, using a classification element, a form type of the document; and based on the form type, identifying the first LM and the schema.

Clause 27: The method of Clause 26, wherein the classification element comprises: a classification model; a second LM; or one or more regular expression rules.

Clause 28: The method of any one of Clauses 26-27, wherein: the form type comprises an invoice, the electronic form comprises an electronic invoice, and the plurality of entities comprise at least one of a customer, a product, a discount rate, a currency, a payment method, a product name, product characteristics, a product type, a price, a quantity, a discount, a name of a purchaser, or an email of the purchaser.

Clause 29: The method of any one of Clauses 26-28, wherein: the form type comprises a bill, the electronic form comprises an electronic bill, and the plurality of entities comprise at least one of a line item, a bill header, an issued date, an address of a client, a due date, payment terms, a name of a product, a name of a service, line item description, a stock keeping unit (SKU) number, a line item quantity, or a unit price.

Clause 30: The method of any one of Clauses 26-29, wherein: the form type comprises an estimate, the electronic form comprises an electronic estimate, and the plurality of entities comprise at least one of a customer, a product, an expiration data, an acceptance date, a discount rate, a currency, a payment method, a product name, product characteristics, a product type, a price, a quantity, a discount, a name of a purchaser, or an email of the purchaser.

Clause 31: The method of any one of Clauses 26-31, wherein: the form type comprises a receipt, the electronic form comprises an electronic receipt, and the plurality of entities comprise at least one of a payment date, a payment method, an account a payment was made from, payment terms, a reference number, a name of a product, a name of a service, a category of a line item, a line item description, a SKU number, a line item quantity, a unit price, a name of a payee, an email of the payee, or an address of the payee.

Clause 32: The method of any one of Clauses 18-31, wherein the LM is prompted based on a prompt comprising: an indication of the document; instructions to call a structured output function; guidelines for calling the structured output function; and an indication of the schema.

Clause 33: The method of Clause 32, wherein the prompt further comprises an output format for the structured output.

Clause 34: The method of any one of Clauses 18-33, further comprising: generating optical character recognition (OCR) data for the document, wherein prompting the first LM to extract, from the document, the plurality of values comprises prompting the first LM to extract, from the OCR data, the plurality of values.

Clause 35: A processing system, comprising: a memory comprising computer-executable instructions; and a processor configured to execute the computer-executable instructions and cause the processing system to perform a method in accordance with any one of Clauses 1-34.

Clause 36: A processing system, comprising means for performing a method in accordance with any one of Clauses 1-34.

Clause 37: A non-transitory computer-readable medium storing program code for causing a processing system to perform the steps of any one of Clauses 1-34.

Clause 38: A computer program product embodied on a computer-readable storage medium comprising code for performing a method in accordance with any one of Clauses 1-34.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of classification-based data handling, comprising:
determining, using a classification element, a form type of a document;
identifying a first language model (LM) and a schema associated with the form type;
prompting the first LM to:
extract, from the document, a plurality of values for a plurality of entities defined in the schema, and
generate, based on the plurality of values, a structured output in compliance with the schema;
receiving, from the first LM, the structured output;
populating an electronic form based on the structured output; and
outputting the electronic form.

2. The method of claim 1, further comprising: updating the structured output based on determining whether each value of the plurality of values included in the structured output matches any database value of a plurality of database values stored in a database.

3. The method of claim 2, wherein updating the schema based on determining whether each value of the plurality of values included in the structured output matches any database value comprises:
determining at least one value of the plurality of values included in the structured output matches a database value of the plurality of database values; and
updating the structured output to include an identifier associated with the database value.

4. The method of claim 3, wherein determining the at least one value of the plurality of values included in the structured output matches the database value comprises:
sending, to a database service associated with the database, an application programming interface (API) request to identify whether the at least one value of the plurality of values included in the structured output matches any database value; and
receiving, from the database service, via an API response, the identifier associated with the database value that matches the at least one value of the plurality of values.

5. The method of claim 2, wherein updating the schema based on determining whether each value of the plurality of values included in the structure output matches any database value comprises:
determining at least one value of the plurality of values included in the structure output does not match any database value of the plurality of database values; and
updating the structured output to indicate that the at least one value does not match any database value.

6. The method of claim 5, wherein determining the at least one value of the plurality of values included in the structured output does not match any database value comprises:
sending, to a database service associated with the database, an API request to identify whether the at least one value of the plurality of values included in the structured output matches any database value; and
receiving, from the database service, via an API response, an indication that the at least one value of the plurality of values included in the structured output does not match any database value.

7. The method of claim 5, further comprising including, in the structured output, a review item for the at least one value.

8. The method of claim 7, wherein populating the electronic form based on the structured output comprises:
requesting a user to provide information about the at least one value;
receiving the information from the user; and
populating the electronic form further based on the information.

9. The method of claim 1, wherein the classification element comprises:
a classification model;
a second LM; or
one or more regular expression rules.

10. The method of claim 1, wherein:
the form type comprises an invoice,
the electronic form comprises an electronic invoice, and
the plurality of entities comprise at least one of a customer, a product, a discount rate, a currency, a payment method, a product name, product characteristics, a product type, a price, a quantity, a discount, a name of a purchaser, or an email of the purchaser.

11. The method of claim 1, wherein:
the form type comprises a bill,
the electronic form comprises an electronic bill, and
the plurality of entities comprise at least one of a line item, a bill header, an issued date, an address of a client, a due date, payment terms, a name of a product, a name of a service, line item description, a stock keeping unit (SKU) number, a line item quantity, or a unit price.

12. The method of claim 1, wherein:
the form type comprises an estimate,
the electronic form comprises an electronic estimate, and
the plurality of entities comprise at least one of a customer, a product, an expiration data, an acceptance date, a discount rate, a currency, a payment method, a product name, product characteristics, a product type, a price, a quantity, a discount, a name of a purchaser, or an email of the purchaser.

13. The method of claim 1, wherein:
the form type comprises a receipt,
the electronic form comprises an electronic receipt, and
the plurality of entities comprise at least one of a payment date, a payment method, an account a payment was made from, payment terms, a reference number, a name of a product, a name of a service, a category of a line item, a line item description, a SKU number, a line item quantity, a unit price, a name of a payee, an email of the payee, or an address of the payee.

14. The method of claim 1, wherein the LM is prompted based on a prompt comprising:
an indication of the document;
instructions to call a structured output function;
guidelines for calling the structured output function; and
an indication of the schema.

15. The method of claim 14, wherein the prompt further comprises an output format for the structured output.

16. The method of claim 1, further comprising:
generating optical character recognition (OCR) data for the document,
wherein prompting the first LM to extract, from the document, the plurality of values comprises prompting the first LM to extract, from the OCR data, the plurality of values.

17. The method of claim 1, further comprising:
prompting a second LM to generate a summary for the structured output; and
storing the summary in a repository.

18. A method of data handling, comprising:
prompting a first language model (LM) to:
extract, from a document, a plurality of values for a plurality of entities defined in a schema, and
generate, based on the plurality of values, a structured output in compliance with the schema;
receiving, from the first LM, the structured output;
populating an electronic form based on the structured output;
obtaining one or more analytics associated with prompting the first LM and populating the electronic form; and
storing the document, the electronic form, and the one or more analytics in a repository.

19. The method of claim 18, further comprising: updating the structured output based on determining whether each value of the plurality of values included in the structured output matches any database value of a plurality of database values stored in a database.

20. A processing system, comprising: a memory comprising computer-executable instructions; and a processor configured to execute the computer-executable instructions and cause the processing system to:
determine, using a classification element, a form type of a document;
identify a first language model (LM) and a schema associated with the form type;
prompt the first LM to:
extract, from the document, a plurality of values for a plurality of entities defined in the schema, and
generate, based on the plurality of values, a structured output in compliance with the schema;
receive, from the first LM, the structured output;
populate an electronic form based on the structured output; and
output the electronic form.
